(19) United States
(12) Patent Application Publication
(10) Pub. No.: US 2023/0004485 A1
(43) Pub. Date: Jan. 5, 2023

(54) TECHNIQUES FOR AUTOMATICALLY GENERATING SOFTWARE TESTING CONFIGURATION DATA ENTITIES

(71) Applicant: Infor (US), LLC, New York, NY (US)

(72) Inventors: Ranasinghage Piyaviraj Ranasinghe, Piliyandala (LK); Jeffrey Allen Brown, Colorado Springs, CO (US); Tharaka Deshan Hewa Walpita, Pannipitiya (LK)

(21) Appl. No.: 17/365,269

(22) Filed: Jul. 1, 2021

(51) Int. Cl. G06F 11/36; G06F 21/60

(52) U.S. Cl. CPC G06F 11/3688; G06F 21/604

(57) ABSTRACT

Various embodiments of the present invention provide methods, apparatuses, systems, computing devices, computing entities, and/or the like for automatically testing workflow data entities based at least in part on user action graphs that are generated based at least in part on user action data for a plurality of user profiles. In doing so, various embodiments of the present invention address technical challenges related to software testing and make substantial technical improvements to improving the computational efficiency, traceability, and operational reliability of both test automation platforms and manual software testing platforms.

### BACKGROUND

Various embodiments of the present invention address technical challenges related to software testing and make substantial technical improvements to improving the computational efficiency, traceability, and operational reliability of both test automation platforms and manual software testing platforms. Various embodiments of the present invention make important technical contributions to the operational reliability of software applications that are tested using the software application platforms.

### BRIEF SUMMARY

In general, various embodiments of the present invention provide methods, apparatuses, systems, computing devices, computing entities, and/or the like for automatically testing workflow data entities based at least in part on user action graphs that are generated based at least in part on user action data for a plurality of user profiles. In doing so, various embodiments of the present invention address technical challenges related to software testing and make substantial technical improvements to improving the computational efficiency, traceability, and operational reliability of both test automation platforms and manual software testing platforms.

In accordance with one aspect, a method is provided. In one embodiment, the method comprises: generating a user action graph associated with the user action data, wherein the user action graph comprises: (i) a plurality of user action nodes corresponding to a plurality of recorded user actions, and (ii) one or more user action sequence edges that describe sequential relationships across the plurality of recorded user actions; for each user action node, determining one or more centrality degree scores with respect to the user action graph; detecting the one or more one or more automated testing workflow data entities based at least in part on each centrality degree for a user action node; and providing access to the one or more automated testing workflow data entities, wherein the one or more automated testing workflow data entities are configured to enable executing one or more automated software testing operations.

In accordance with another aspect, a computer program product is provided. The computer program product may comprise at least one computer-readable storage medium having computer-readable program code portions stored therein, the computer-readable program code portions comprising executable portions configured to: generate a user action graph associated with the user action data, wherein the user action graph comprises: (i) a plurality of user action nodes corresponding to a plurality of recorded user actions, and (ii) one or more user action sequence edges that describe sequential relationships across the plurality of recorded user actions; for each user action node, determine one or more centrality degree scores with respect to the user action graph; detect the one or more one or more automated testing workflow data entities based at least in part on each centrality degree for a user action node; and provide access to the one or more automated testing workflow data entities, wherein the one or more automated testing workflow data entities are configured to enable executing one or more automated software testing operations.

In accordance with yet another aspect, an apparatus comprising at least one processor and at least one memory including computer program code is provided. In one embodiment, the at least one memory and the computer program code may be configured to, with the processor, cause the apparatus to: generate a user action graph associated with the user action data, wherein the user action graph comprises: (i) a plurality of user action nodes corresponding to a plurality of recorded user actions, and (ii) one or more user action sequence edges that describe sequential relationships across the plurality of recorded user actions; for each user action node, determine one or more centrality degree scores with respect to the user action graph; detect the one or more one or more automated testing workflow data entities based at least in part on each centrality degree for a user action node; and provide access to the one or more automated testing workflow data entities, wherein the one or more automated testing workflow data entities are configured to enable executing one or more automated software testing operations.

### BRIEF DESCRIPTION OF THE DRAWINGS

Having thus described the invention in general terms, reference will now be made to the accompanying drawings, which are not necessarily drawn to scale, and wherein:

FIG. 1 provides an exemplary overview of a system that can be used to practice embodiments of the present invention;

FIG. 2 provides an example web server computing entity in accordance with some embodiments discussed herein;

FIG. 3 provides an example client computing entity in accordance with some embodiments discussed herein;

FIG. 4 is a flowchart diagram of an example process for performing executing one or more automated software testing operations using automated testing workflow data entities that are based at least in part on user action data associated with a plurality of user profiles as well as behavior driving parameters of a user action graph of the user action data in accordance with some embodiments discussed herein;

FIG. 5 provides an operational example of retrieving user action data for a corresponding geographic region in accordance with some embodiments discussed herein;

FIG. 6 provides an operational example of a JavaScript Object Notation (JSON) user action event in accordance with some embodiments discussed herein;

FIG. 7 provides an operational example of an overall user action graph that is generated based at least in part on a set of user action events in accordance with some embodiments discussed herein;

FIG. 8 is a flowchart diagram of an example process for generating automated testing workflow data entities based at least in part on a target user action graph in accordance with some embodiments discussed herein; and

FIG. 9 provides an operational example of a user interface that provides alteration data describing relationships between detected behavior driving parameters and detected automated testing workflow data entities in accordance with some embodiments discussed herein.

### DETAILED DESCRIPTION

Various embodiments of the present invention are described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present invention are described with reference to predictive data analysis, one of ordinary skill in the art will recognize that the disclosed concepts can be used to execute other types of data analysis.

### Overview and Technical Advantages

Various embodiments of the present invention describe techniques for reducing operational load on software testing platforms by automatically generating automated testing workflow data entities. For example, various embodiments of the present invention provide techniques for generating automated testing workflow data entities based at least in part on user action data associated with a plurality of user profiles as well as behavior driving parameters of a user action graph of the user action data. The noted techniques reduce the number of user operations needed to manually define automated testing workflow data entities, which in turn reduces the overall operational load on software testing platforms and increases the computational efficiency and operational reliability of the noted software testing platforms.

Moreover, various embodiments of the present invention increase the operational effectiveness of software testing platforms by automatically generating automated testing workflow data entities based at least in part on detected patterns of user data. For example, various embodiments of the present invention provide techniques for determining workflow starting point nodes for automated testing workflow data entities, workflow end-point nodes for automated testing workflow data entities, and/or behavior driving parameters from a set of user action nodes of a user action graph that is generated based at least in part on user action events of a particular set of user action data. The automated detection of workflow starting point nodes for automated testing workflow data entities, workflow end-point nodes for automated testing workflow data entities, and/or behavior driving parameters enable performing automated software testing operations in a more comprehensive way and with respect to usage patterns known to users that may be even unknown to test developers. This in turn increases the operational effectiveness and utility of software testing platforms, as well as the operational reliability and user-friendliness of the software applications that are tested and verified using the noted software testing platforms.

While various embodiments of the present invention describe generating automated testing workflow data entities that are based at least in part on user action data associated with a plurality of user profiles as well as behavior driving parameters of a user action graph of user action data to generate automated testing workflow data entities, a person of ordinary skill in the relevant technology will recognize that the disclosed techniques can be used to generate other types of software testing configuration data entities, such as test case data entities.

### Definitions of Certain Terms

The term “test case data entity” may refer to a data construct that is configured to describe data associated with a test case, where the test case may in turn describe a specification of the inputs, execution conditions, testing procedure, and expected results (e.g., including explicitly defined assertions as well as implicitly generated expected results such as the expected result that typing a value into a field causes the value to appear in the field) that define a test that is configured to be executed to achieve a particular software testing objective, such as to exercise a particular program path or to verify compliance with a specific operational requirement. In some embodiments, the test case data entity may be configured to describe test case data (e.g., webpage sequence data, user interaction sequence data, application programming interface (API) call sequence data, and/or the like) associated with a corresponding test case. In some embodiments, a test case data entity is configured to describe: (i) one or more test case page images associated with the test case, and (ii) for each test case page image of the one or more test case page images, a set of test case steps that relate to the test case page image.

The term “test case page image” may refer to a data construct that is configured to describe an image associated with a state of a webpage that is visited during a test. For example, in some embodiments, a test case page image may depict a webpage image that is determined based at least in part on a session data entity associated with the test case data entity (as further described below). As another example, in some embodiments, a test case page image may depict a user-uploaded and/or user-selected image that is configured to depict a state of a webpage associated with a corresponding test case data entity. In some embodiments, each visited webpage associated with a test case data entity may be associated with more than one test case page image, where each test case page image may depict a different state of the visited webpage. For example, consider a webpage that includes a dropdown menu interactive page element. In the noted example, some test case page images associated with the webpage may depict a visual state of the webpage in which the dropdown menu interactive page element is in a non-expanded state, while other test case page images associated with the webpage may depict a visual state of the webpage in which the dropdown menu interactive page element is in an expanded state. As another example, consider a webpage that is configured to generate a transitory notification (e.g., a transitory notification that is generated in response to a defined user action, such as in response to the user hovering over an interactive page element and/or in response to the user selecting an interactive button). In the noted example, some test case page images associated with the webpage may depict a visual state of the webpage in which the transitory notifications are displayed, while other test case page images associated with the webpage may depict a visual state of the webpage in which the transitory notifications are not displayed.

The term “test case step” may refer to a data construct that is configured to describe a user action required by a test associated with a corresponding test case data entity, where the user action may be performed with respect to an interactive page element of a webpage associated with a test case page image of the corresponding test case data entity. In some embodiments, a test case step may be associated with test case data used to generate at least one of the following: (i) a visual element identifier overlaid on the test case page image in an overlay location associated with a region of the test case page image that corresponds to the interactive page element for the test case step (e.g., is defined in relation to the interactive page element, for example is placed at the upper left of the interactive page element); and (ii) a test case step action feature that describes one or more action features of the user action associated with the test case step. For example, if a test case step corresponds to the user action of selecting a particular button on a particular webpage, the test case step may describe data corresponding to a visual element identifier overlaid on an image region of a test case page image for the particular webpage that corresponds to (e.g., is defined in relation to) a location of the particular button on the particular webpage. In the noted example, the test case step may describe data associated with action features of a user action that may be used to generate a test case step action feature. An action feature of a user action may describe any property of a user action that is configured to change a state and/or a value of an interactive page element within a webpage. Examples of action features for a user action include (i) a user action type of the user action that may describe a general input mode of user interaction with the interactive page element associated with the user action; (ii) a user input value of the user action that may describe a value provided by the user to an interactive page element; (iii) a user action sequence identifier of the user action that may describe a temporal order of the user action within a set of sequential user actions performed with respect to interactive page elements of a webpage associated with the user action; and (iv) a user action time of the user action that may describe a captured time of the corresponding user action, and/or the like.

The term “automated testing workflow data entity” may refer to a data construct that is configured to describe a sequence of web-based actions that may be executed to generate an automated testing operation associated with a software test that is configured to be executed to achieve a particular software testing objective, such as to exercise a particular program path or to verify compliance with a specific operational requirement. For example, the automated testing workflow data entity may describe a sequence of webpages associated with a software testing operation, where each webpage may in turn be associated with a set of automated testing workflow steps. The sequence of webpages and their associated automated testing workflow steps may then be used to generate automation scripts for the software testing operation, where the automation script may be executed by an execution agent in order to execute the software testing operation and generate a software testing output based at least in part on a result of the execution of the automation script. In some embodiments, an automated testing workflow data entity is determined based at least in part on a test case data entity for the corresponding software testing operation, where the test case data entity may describe data associated with a test case, where the test case may in turn describe a specification of the inputs, execution conditions, testing procedure, and expected results that define a test that is configured to be executed to achieve a particular software testing objective, such as to exercise a particular program path or to verify compliance with a specific operational requirement.

The term “automated testing workflow step” may refer to a data construct that is configured to describe a user action required by a software testing operation associated with a corresponding automated testing workflow data entity, where the user action may be executed with respect to an interactive page element of a webpage associated with a captured page image of the corresponding automated testing workflow data entity. In some embodiments, an automated testing workflow step may be associated with: (i) an image region of the corresponding captured page image that corresponds to the interactive page element for the automated testing workflow step; and (ii) a workflow step action feature element that describes one or more action features of the user action associated with the automated testing workflow step. For example, if an automated testing workflow step corresponds to the user action of selecting a particular button on a particular webpage, the automated testing workflow step may describe data corresponding to an image region of a captured image for the particular webpage that corresponds to (e.g., is defined in relation to) a location of the particular button on the particular webpage. In the noted example, the automated testing workflow step may describe data associated with action features of a user action that may be used to generate a workflow step action feature element for the automated testing workflow step. An action feature of a user action may describe any property of a user action that is configured to change a state and/or a value of an interactive page element within a webpage. Examples of action features for a user action include: (i) a user action type of the user action that may describe a general input mode of user interaction with the interactive page element associated with the user action; (ii) a user input value of the user action that may describe a value provided by the user to an interactive page element; (iii) a user action sequence identifier of the user action that may describe a temporal order of the user action within a set of sequential user actions executed with respect to interactive page elements of a webpage associated with the user action; and (iv) a user action time of the user action that may describe a captured time of the corresponding user action, and/or the like.

The term “software testing configuration data entity” may refer to a data construct that is configured to describe steps of a software testing procedure using software testing configuration steps. Therefore, any data entity that describes one or more steps of a software testing procedure can be compared to other data entities describing one or more steps of another software testing procedure according to at least some embodiments of the invention described herein. Examples of software testing configuration data entities include test case data entities and automated testing workflow data entities, as those terms are further described below. Examples of software testing configuration steps include test case steps of a test case data entity and automated testing workflow steps of an automated testing workflow data entity, as those terms are described in greater detail below.

The term “software testing configuration step” may refer to a data construct that is configured to describe a component of a software testing configuration data entity that describes a software testing operation in a software testing procedure that is associated with the software testing configuration data entity. Examples of software testing configuration steps include test case steps of a test case data entity and automated testing workflow steps of an automated testing workflow data entity, as those terms are further described above.

The term “user action graph” may refer to a data construct that is configured to describe user action sequences associated with a plurality of user profiles. For example, a user action graph may describe a set of user action node each associated with a recorded user action that has been performed by at least n (e.g., at least one) user profiles of the plurality of user profiles, as well as a set of user action sequence edges that each describes that at least m (e.g., at least one) user profile of the group of profiles have performed a second recorded user action for a second user action node that is associated with a user action sequence edge sequentially after a first recorded user action for a first user action node that is associated with the user action sequence edge. In an exemplary embodiment, when a first user action node describes a recorded user action of clicking on a first button and a second user action node of clicking on a second button, a user action sequence edge may be a directed edge from the first user action node to the second user action node, and may describe that at least m (e.g., at least one) user profile has clicked on the second button sequentially subsequent to clicking on the first button. As used herein, the term “user action graph” may include any collection of user action nodes and user action sequence edges. Thus, in embodiments where an overall user action graph for all of user action data associated with a plurality of user profiles is processed using a community detection routine in order to generate one or more correlated subgraphs of the noted overall user action graph, both the overall user action graph and each of the one or more correlated subgraphs may in some embodiments be deemed a user action graph as described herein. As described below, in some embodiments, a user action graph may be generated based at least in part on a set of user action events for a plurality of user profiles, for example user action events related to a corresponding geographic region, user action events related to a corresponding time shift designation, user action events that are associated with a designated recent time period, and/or the like. In some embodiments, the user action data comprise one or more user action events for each user profile, and the one or more user action events for a user profile are recorded by a screen capture component executing on a computing device of the user profile in response to detecting an indication that the user profile has granted permission for the screen capture component to record user activity of the user profile.

The term “user action node” may refer to a data construct that is configured to describe a recorded user action associated with a plurality of user profiles as part of a user action graph that describes user action sequences associated with a plurality of user profiles. In some embodiments, a user action node describes a recorded user action that has been performed by at least n (e.g., at least one) user profiles of the plurality of user profiles. In an exemplary embodiment, when a first user action node describes a recorded user action of clicking on a first button and a second user action node of clicking on a second button, a user action sequence edge may be a directed edge from the first user action node to the second user action node, and may describe that at least m (e.g., at least one) user profile has clicked on the second button sequentially subsequent to clicking on the first button. In some embodiments, a user action graph comprising a set of user action nodes may be generated based at least in part on a set of user action events for a plurality of user profiles, for example user action events related to a corresponding geographic region, user action events related to a corresponding time shift designation, user action events that are associated with a designated recent time period, and/or the like. In some embodiments, the user action data comprise one or more user action events for each user profile, and the one or more user action events for a user profile are recorded by a screen capture component executing on a computing device of the user profile in response to detecting an indication that the user profile has granted permission for the screen capture component to record user activity of the user profile.

The term “user action sequence edge” may refer to a data construct that is configured to describe a recorded user action sequence between two recorded user actions that are associated with two user action nodes for the user action sequence edge, where the user action sequence edge is part of a user action graph that describes user action sequences associated with a plurality of user profiles. In some embodiments, a user action sequence edge describes that at least m (e.g., at least one) user profiles of the group of profiles have performed a second recorded user action for a second user action node that is associated with a user action sequence edge sequentially after a first recorded user action for a first user action node that is associated with the user action sequence edge. In an exemplary embodiment, when a first user action node describes a recorded user action of clicking on a first button and a second user action node of clicking on a second button, a user action sequence edge may be a directed edge from the first user action node to the second user action node, and may describe that at least m (e.g., at least one) user profile has clicked on the second button sequentially subsequent to clicking on the first button. In some embodiments, a user action graph comprising a set of user action sequence edges may be generated based at least in part on a set of user action events for a plurality of user profiles, for example user action events related to a corresponding geographic region, user action events related to a corresponding time shift designation, user action events that are associated with a designated recent time period, and/or the like. In some embodiments, the user action data comprise one or more user action events for each user profile, and the one or more user action events for a user profile are recorded by a screen capture component executing on a computing device of the user profile in response to detecting an indication that the user profile has granted permission for the screen capture component to record user activity of the user profile.

The “centrality degree score” may refer to a data construct that is configured to describe at least one of the following: (i) a number of user action sequence edges in a user action graph that start from a corresponding user action node, and (ii) a number of user action sequence edges in a user action graph that end with a corresponding user action node. For example, in some embodiments, a centrality degree score describes a number of user action sequence edges in a user action graph that start from a corresponding user action node. As another example, in some embodiments, a centrality degree score describes a number of user action sequence edges in a user action graph that end with a corresponding user action node. As yet another example, in some embodiments, a centrality degree score describes a sum of the following: (i) a number of user action sequence edges in a user action graph that start from a corresponding user action node, and (ii) a number of user action sequence edges in the user action graph that end with the corresponding user action node. In some embodiments, when a centrality degree score describes a number of user action sequence edges in a user action graph that start from a corresponding user action node, the noted centrality degree score is referred to as the inward centrality degree score of the corresponding user action node. In some embodiments, when a centrality degree score describes a number of user action sequence edges in a user action graph that end with a corresponding user action node, the noted centrality degree score is referred to as the outward centrality degree score of the corresponding user action node. In some embodiments, centrality degree scores are used to determine at least one of the following: a set of workflow starting point nodes of the user action nodes of a user action graph, a set of workflow end-point nodes of the user action nodes of a user action graph, and a set of behavior driving parameters of the set of user action nodes of a user action graph, as further described in greater detail below.

The term “workflow starting point node” may refer to a data construct that is configured to describe a user action node of a user action graph that is determined to be a predicted starting point for a sequence of user action nodes described by the user action graph that are deemed suitable to be tested as a unit as an automated testing workflow data entity. For example, in some embodiments, a workflow starting point node may be determined based at least in part on centrality degree scores associated with a set of user action nodes of a user action graph, such as based at least in part on inward centrality degree scores associated with the noted set of user action nodes. In some embodiments, a user action node of a user action graph is deemed to be a workflow starting point node if (e.g., in addition to satisfying one or more other conditions) the user action node is deemed to have a sufficiently low inward centrality degree score, e.g., if the inward centrality degree score for the user action node satisfies (e.g., is below) a lower bound inward centrality degree score threshold, such as a lower bound inward centrality degree score threshold that is a fixed value and/or a lower bound inward centrality degree score threshold that is determined based at least in part on a measure of distribution of inward centrality degree scores for all of the user action nodes associated with the noted user action graph.

The term “workflow end-point node” may refer to a data construct that is configured to describe a user action node of a user action graph that is determined to be a predicted ending point for a sequence of user action nodes described by the user action graph that are deemed suitable to be tested as a unit as an automated testing workflow data entity. For example, in some embodiments, a workflow end-point point node may be determined based at least in part on centrality degree scores associated with a set of user action nodes of a user action graph, such as based at least in part on outward centrality degree scores associated with the noted set of user action nodes. In some embodiments, a user action node of a user action graph is deemed to be a workflow end-point node if (e.g., in addition to satisfying one or more other conditions) the user action node is deemed to have a sufficiently low outward centrality degree score, e.g., if the outward centrality degree score for the user action node satisfies (e.g., is below) a lower bound outward centrality degree score threshold, such as a lower bound outward centrality degree score threshold that is a fixed value and/or a lower bound outward centrality degree score threshold that is determined based at least in part on a measure of distribution of outward centrality degree scores for all of the user action nodes associated with the noted user action graph.

The term “behavior driving parameter” may refer to a data construct that is configured to describe a user action node of a user action graph that is associated with a user action value (e.g., a user-assigned value and/or a system-generated value), where the user action value is configured to control the flow of user action sequences in a user action graph (e.g., in a manner that can be used to infer two or more subgraphs from the user action graph). In some embodiments, a behavior driving parameter can create alternations to an automated testing workflow of an automated testing workflow data entity based at least in part on the user action value associated with the behavior driving parameter. For example, a behavior driving parameter may be associated with a payment method dropdown selection user interface element (e.g., a payment method dropdown selection webpage element) that may alter a checkout testing workflow (e.g., if the user select a credit card payment method, the workflow may be different than when the user selects a gift card payment method). In general, a behavior driving parameter may be associated with a user interface element (e.g., a webpage element) that can hold a value, such as a dropdown menu user interface element, a checkbox user interface element, a set of radio button user interface elements, a textbox user interface element, and/or the like. In some embodiments, behavior driving parameters are associated with centrality degree scores associated with a set of user action nodes associated with a user action graph, such as with both inward centrality degree scores associated with the noted set of user action nodes and outward centrality degree scores associated with the noted set of user action nodes. In some embodiments, a user action node of a user action graph is deemed to be a behavior driving parameter if (e.g., in addition to satisfying one or more other conditions) the user action node is deemed to have a sufficiently low inward centrality degree score and a sufficiently high outward centrality degree score. For example, in some embodiments, a user action node of a user action graph is deemed to be a behavior driving parameter if (e.g., in addition to satisfying one or more other conditions): (i) the user action node is deemed to have an inward centrality degree score that satisfies (e.g., falls below or is equal to) a lower bound inward centrality degree score threshold (e.g., a fixed lower bound inward centrality degree score threshold such as a fixed lower bound inward centrality degree score threshold of one, a lower bound inward centrality degree score threshold that is determined based at least in part on a measure of distribution of inward centrality degree scores for all of the user action nodes associated with the noted user action graph, and/or the like), and (ii) the user action node is deemed to have an outward centrality degree score that satisfies (e.g., falls above) an upper bound outward centrality degree score threshold (e.g., a fixed upper bound outward centrality degree score threshold, an upper bound outward centrality degree score threshold that is determined based at least in part on a measure of distribution of outward centrality degree scores for all of the user action nodes associated with the noted user action graph, and/or the like). In some embodiments, a user action node of a user action graph is deemed to be a behavior driving parameter if (e.g., in addition to satisfying one or more other conditions): (i) the user action node is associated with an inward centrality degree score of one, and (ii) the user action node is deemed to have an outward centrality degree score that satisfies (e.g., falls above) an upper bound outward centrality degree score threshold (e.g., a fixed upper bound outward centrality degree score threshold, an upper bound outward centrality degree score threshold that is determined based at least in part on a measure of distribution of outward centrality degree scores for all of the user action nodes associated with the noted user action graph, and/or the like). In some embodiments, a user action node of a user action graph is deemed to be a behavior driving parameter if (e.g., in addition to satisfying one or more other conditions) user action node is an articulation node (e.g., a node of a graph such as a user action graph whose failure/removal would cause splitting of a user action graph into two or more disconnected subcomponents). In some embodiments, a user action node of the user action graph is an articulation node if removing the user action node (and the user action sequence edges through it) disconnects the user action graph.

### Computer Program Products, Methods, and Computing Entities

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage median include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatuses, systems, computing devices, computing entities, and/or the like. As such, embodiments of the present invention may take the form of an apparatus, system, computing device, computing entity, and/or the like executing instructions stored on a computer-readable storage medium to execute certain steps or operations. Thus, embodiments of the present invention may also take the form of an entirely hardware embodiment, an entirely computer program product embodiment, and/or an embodiment that comprises combination of computer program products and hardware executing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be executed sequentially such that one instruction is retrieved, loaded, and executed at a time. In some exemplary embodiments, retrieval, loading, and/or execution may be executed in parallel such that multiple instructions are retrieved, loaded, and/or executed together. Thus, such embodiments can produce specifically-configured machines executing the steps or operations specified in the block diagrams and flowchart illustrations. Accordingly, the block diagrams and flowchart illustrations support various combinations of embodiments for executing the specified instructions, operations, or steps.

### Exemplary System Framework

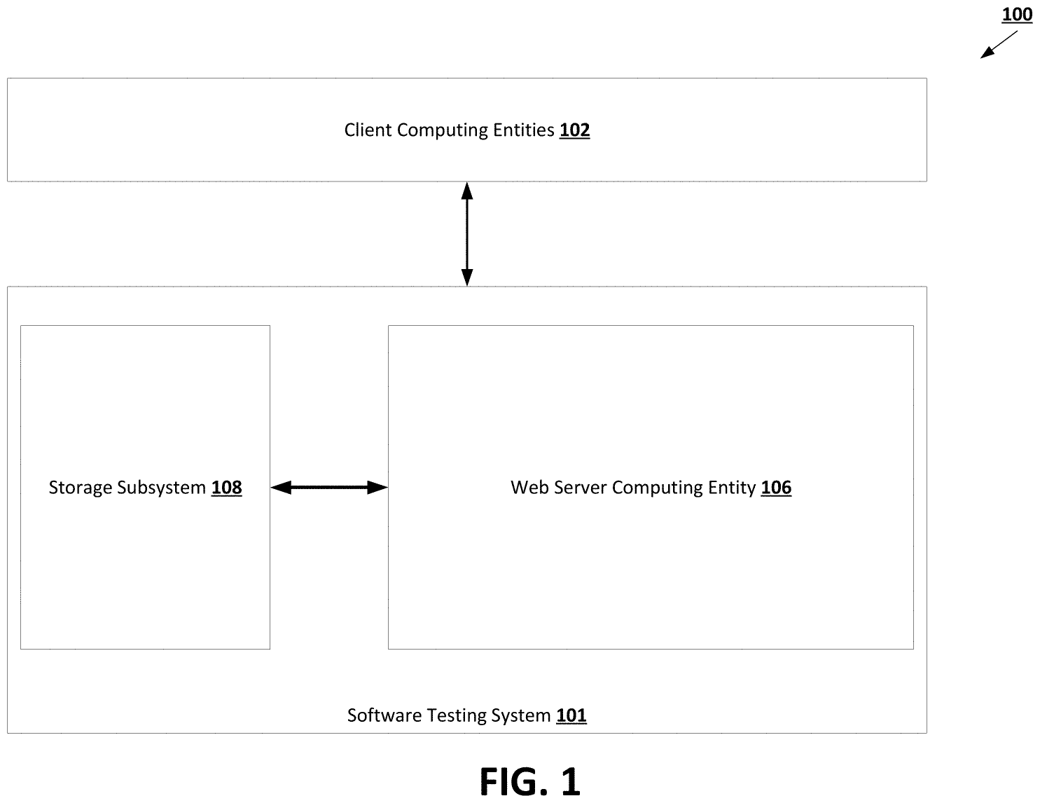

FIG. 1 is a schematic diagram of an example architecture 100 for performing software testing operations. The architecture 100 includes a software testing system 101 configured to receive testing requests from external computing entities, perform testing requests to generate unit testing outputs, and provide unit testing outputs to the client computing entities 102. In some embodiments, the software testing system 101 may perform software testing operations based on software configuration data entities that are determined based on user action data, as further described throughout the present document.

In some embodiments, the software testing system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The software testing system 101 may include a web server computing entity 106 and a storage subsystem 108. The web server computing entity 106 may be configured to receive unit testing requests from external computing entities, perform unit testing requests to generate unit testing outputs, and provide unit testing outputs to the client computing entities 102. The storage subsystem 108 may be configured to store input data used by the web server computing entity 106 to perform functionally targeted unit testing. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Exemplary Web Server Computing Entity

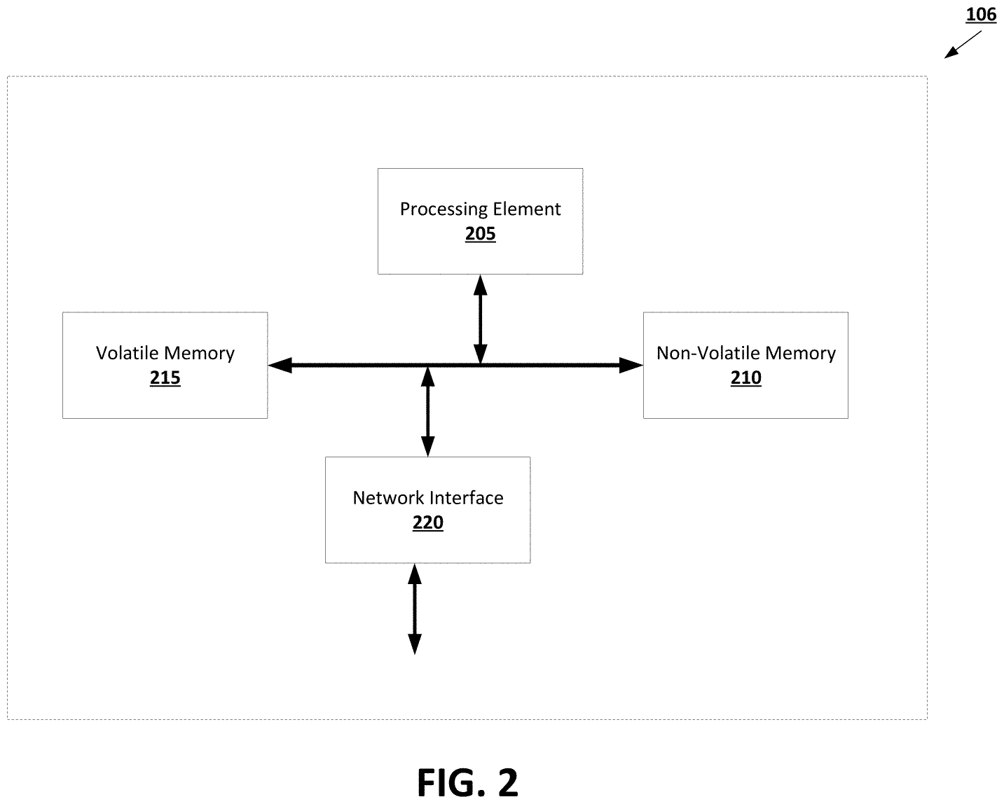

FIG. 2 provides a schematic of a web server computing entity 106 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to execute the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be executed on data, content, information, and/or similar terms used herein interchangeably. While FIG. 2 is described with reference to the web server computing entity 106, a person of ordinary skill in the relevant technology will recognize that the depicted architecture can be used in relation to SUT computing entities and PPV computing entities.

As indicated, in one embodiment, the web server computing entity 106 may also include one or more communications interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the web server computing entity 106 may include, or be in communication with, one or more processing elements 205 (also referred to as processors, processing circuitry, and/or similar terms used herein interchangeably) that communicate with other elements within the web server computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of executing steps or operations according to embodiments of the present invention when configured accordingly.

In one embodiment, the web server computing entity 106 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity— relationship model, object model, document model, semantic model, graph model, and/or the like.

In one embodiment, the web server computing entity 106 may further include, or be in communication with, volatile media (also referred to as volatile storage, memory, memory storage, memory circuitry and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the web server computing entity 106 with the assistance of the processing element 205 and operating system.

As indicated, in one embodiment, the web server computing entity 106 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the web server computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the web server computing entity 106 may include, or be in communication with, one or more input elements, such as a keyboard input, a mouse input, a touch screen/display input, motion input, movement input, audio input, pointing device input, joystick input, keypad input, and/or the like. The web server computing entity 106 may also include, or be in communication with, one or more output elements (not shown), such as audio output, video output, screen/display output, motion output, movement output, and/or the like.

### Exemplary Client Computing Entity

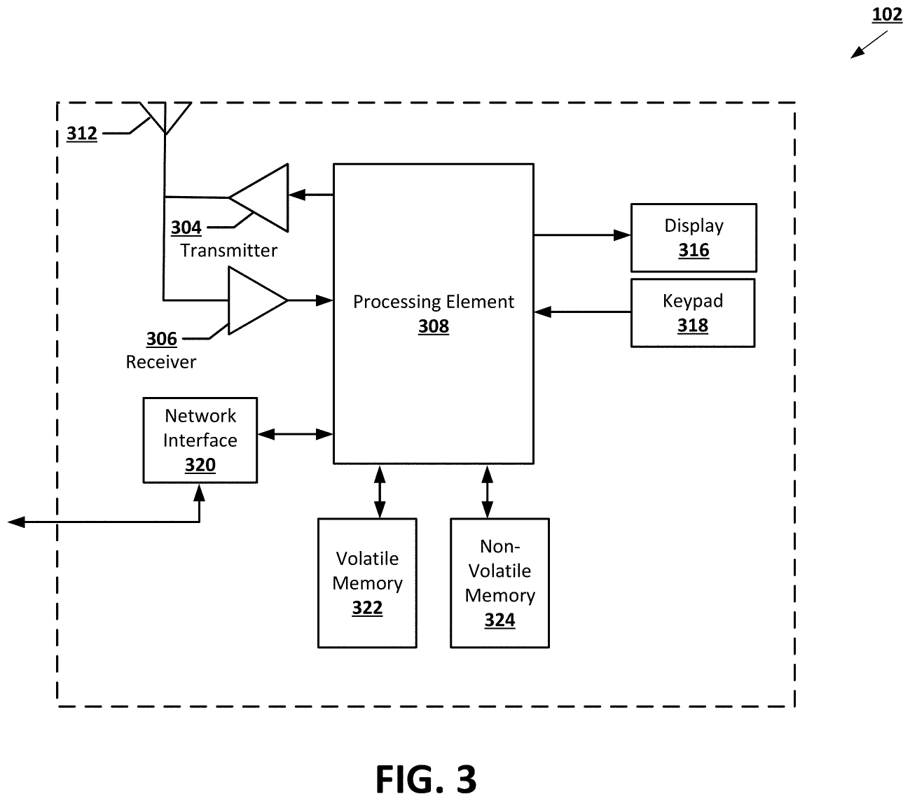

FIG. 3 provides an illustrative schematic representative of an client computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 can be operated by various parties. As shown in FIG. 3, the client computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the web server computing entity 106. In a particular embodiment, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the web server computing entity 106 via a network interface 320.

Via these communication standards and protocols, the client computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 can also download changes, add-ons, and updates, for instance, to its firmware, software (e.g., including executable instructions, applications, program modules), and operating system.

According to one embodiment, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the client computing entity's 102 position in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the web server computing entity 106, as described herein. The user input interface can comprise any of a number of devices or interfaces allowing the client computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The client computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the entity or accessible through a browser or other user interface for communicating with the web server computing entity 106 and/or various other computing entities.

In another embodiment, the client computing entity 102 may include one or more components or functionality that are the same or similar to those of the web server computing entity 106, as described in greater detail above. As will be recognized, these architectures and descriptions are provided for exemplary purposes only and are not limiting to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### Exemplary System Operations

As described below, various embodiments of the present invention describe techniques for reducing operational load on software testing platforms by automatically generating automated testing workflow data entities. For example, various embodiments of the present invention provide techniques for generating automated testing workflow data entities based at least in part on user action data associated with a plurality of user profiles as well as behavior driving parameters of a user action graph of the user action data. The noted techniques reduce the number of user operations needed to manually define automated testing workflow data entities, which in turn reduces the overall operational load on software testing platforms and increases the computational efficiency and operational reliability of the noted software testing platforms.

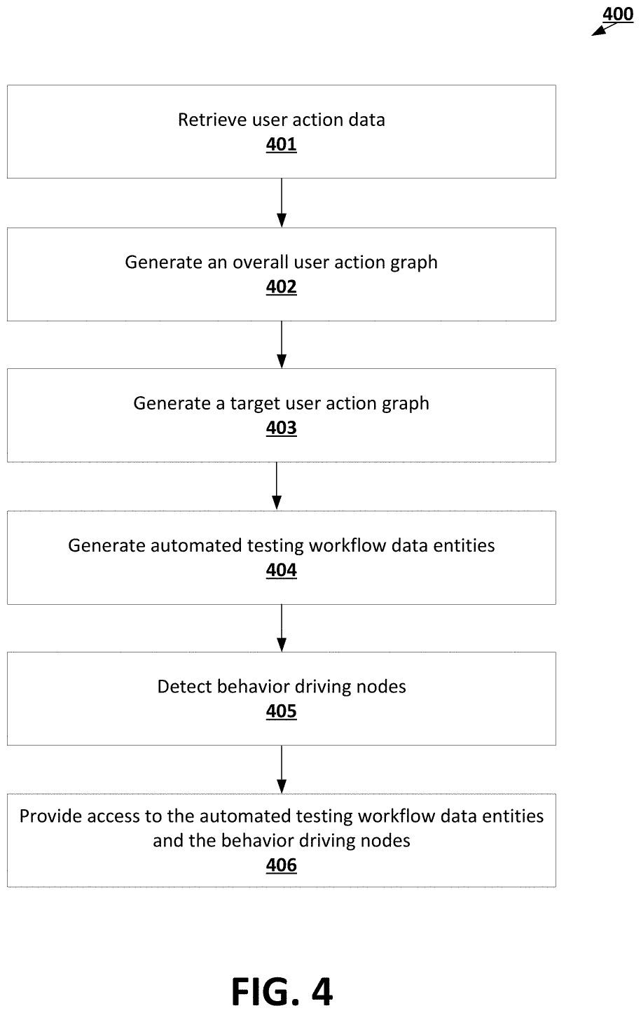

FIG. 4 is a flowchart diagram of an example process 400 for performing executing one or more automated software testing operations using automated testing workflow data entities that are based at least in part on user action data associated with a plurality of user profiles as well as behavior driving parameters of a user action graph of the user action data. Via the various steps/operations of the process 400, the web server computing entity 106 can efficiently and effectively process user action data associated with a group of user profiles to automatically detect user action trends and use the detected user action trends to generate testing configuration data entities that may be used for executing one or more automated software testing operations. While various embodiments of the present invention describe generating automated testing workflow data entities that are based at least in part on user action data associated with a plurality of user profiles as well as behavior driving parameters of a user action graph of user action data to generate automated testing workflow data entities, a person of ordinary skill in the relevant technology will recognize that the disclosed techniques can be used to generate other types of software testing configuration data entities, such as test case data entities.

The process 400 begins at step/operation 401 when the web server computing entity 106 retrieves user action data for the plurality of user profiles. In some embodiments, the user action data include bulk user action data in an anonymized form for a set of user profiles. In some embodiments, the user action data comprise one or more user action events for each user profile, and the one or more user action events for a user profile are recorded by a screen capture component executing on a computing device of the user profile in response to detecting an indication that the user profile has granted permission to the screen capture component to record user activity of the user profile (e.g., by toggling a button such as a web browser button configured to grant such permission).

In some embodiments, the user action data include a set of user action events. For example, in some embodiments, the user action data include a set of user action events related to a corresponding geographic region (e.g., a Europe region). As another example, in some embodiments, the user action data include a set of user action events related to a corresponding time shift designation (e.g., morning shift, evening shift, and/or the like). In some embodiments, the user action data include a set of user action events that are associated with a designated recent time period. For example, in some embodiments, the user action data include a set of user action events that are associated with the last three months. In some embodiments, the designated recent time period may be statistically determined based at least in part on a fixed value and/or may be dynamically determined based at least in part on a distribution of timestamps associated with the set of user action events (e.g., based on a mean of the of timestamps associated with the set of user action events).

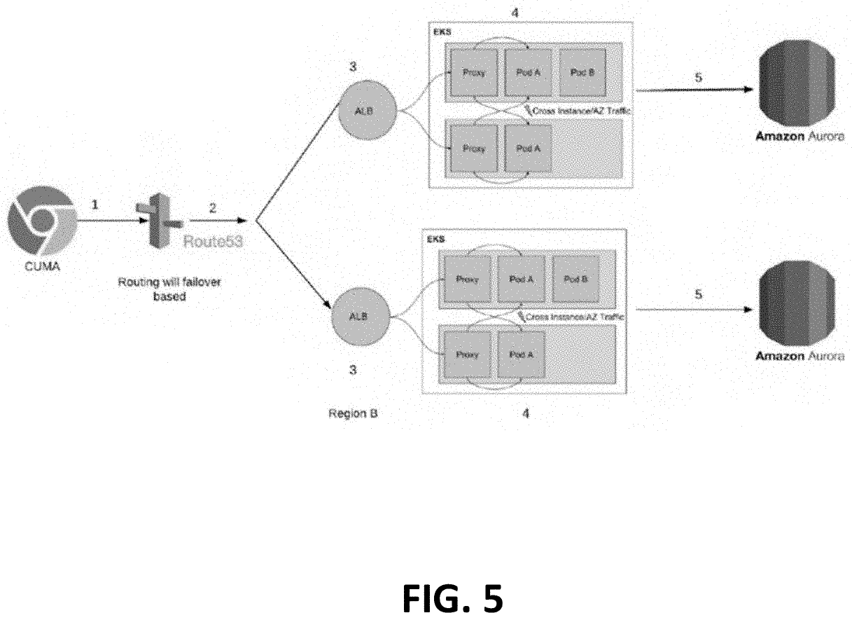

In some embodiments, retrieving user action data may include retrieving user action data associated with a particular geographic region (e.g., in order to detect user action trends associated with user profiles of the particular geographic region). An operational example of retrieving user action data for a corresponding geographic region is depicted in FIG. 5. As depicted in FIG. 5, retrieving the user action data includes retrieving user action events associated with a particular geographic region, which is designated as Region B in the depicted operational example of FIG. 5.

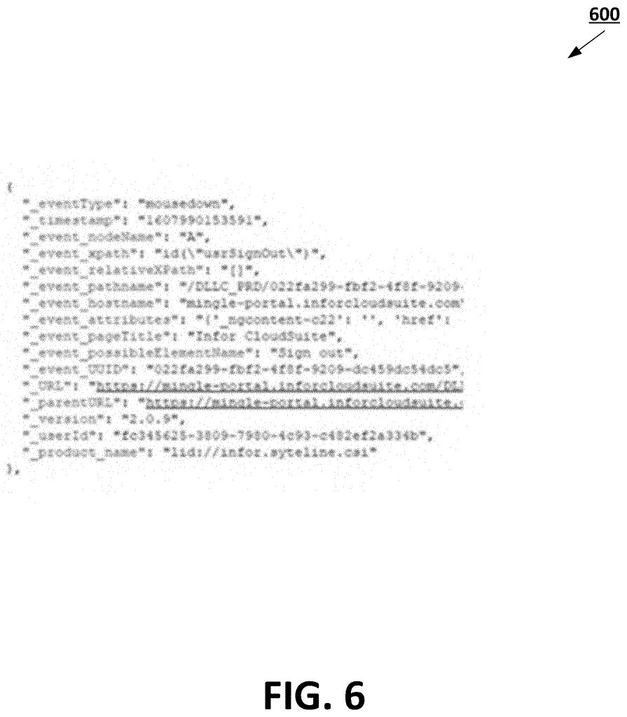

In some embodiments, the user action data include a set of user action events. In some embodiments, a user action event is a structured data item that describes one or more features of a recorded user action associated with the user action event. For example, in some embodiments, a user action event is a JavaScript Object Notation (JSON) data item. An operational example of a user action event 600 that is a JSON data item is depicted in FIG. 6.

In some embodiments, user action event data may be recorded by attaching to JavaScript event listener methods when a user toggles a button providing permission to record such user action event data. In some embodiments, to identify a user action event, the web server computing entity 106 identifies the set of captured user interactions associated with the user action event. In some embodiments, a screen capture component (which may, for example, be a JavaScript extension) attaches itself to listener methods of at least some of the page elements (e.g., a set of page elements that are deemed to be actionable page elements based at least in part on actionable page element detection rules associated with the screen capture component) in the HTML, code of the webpages associated with the captured session, and then detecting the set of captured user interactions based at least in part on the data detected via listening to the listener methods. After detecting the captured user interactions, the screen capture component may transmit the noted captured user interactions to the web server computing entity 106. In some embodiments, the web server computing entity 106 identifies actionable page elements associated with a webpage based at least in part on a set of page elements that are associated with listener methods (e.g., JavaScript listener methods), as determined based at least in part on the HTML DOM for the webpage. In some embodiments, subsequent to beginning of recording of a session, a screen capture component (e.g., a web browser extension) injects event listeners into a webpage. If the event listener detects performance of an action, the screen capture component determines whether the webpage has a custom title defined. If the webpage has a custom title defined, the custom page title is adopted as a page title for the page; otherwise, default page title generation logics are used to generate the page title. Subsequent to determining the page title, the screen capture component generates a page checksum for the page based at least in part on the page title, generates a screenshot of the page, generates an image checksum for the webpage based at least in part on the visible page elements in accordance with the screenshots, collects any required metadata about the webpage, and sends the screenshot, the checksums, and the collected metadata to the web server computing entity 106. The web server computing entity 106 may be configured to determine if the page checksum exists in a page library. If the page checksum exists, the web server computing entity 106 identifies the existing page for the webpage and iterates over the page elements of the existing page to determine whether each page element exists, add location data for non-existent page elements, and replace location data of existing page elements. If the page checksum does not exist, the web server computing entity 106 creates a new page and adds elements (along with location data of the page elements) for the newly-added page. The web server computing entity 106 may further be configured to determine whether the image checksum exists. If the image checksum exists, the web server computing entity 106: (i) iterates over screen elements (i.e., page elements depicted by the corresponding screenshot) by determining whether each screen element exists and inserting new screen elements with coordinates for non-existent elements, and (ii) replaces element coordinates for existing screen elements if a coordinate checksum of the existing screenshot and a coordinate checksum of a new screenshot do not match. If the image checksum does not exist, the web server computing entity 106 saves the new screenshots with all corresponding screen element coordinates.

At step/operation 402, the web server computing entity 106 generates an overall user action graph based at least in part on the user action data. In some embodiments, subsequent to generating the overall user action graph, the web server computing entity 106 preprocesses the overall user action graph by removing self-loops (e.g., sets of user action nodes connected by user action sequence edges that are repeated across the overall user action graph) from the overall user action graph. In some embodiments, generating a target user action graph comprises generating an overall user action graph based at least in part on the user action data; generating, by applying a community detection routine (e.g., a Louvain community detection algorithm) to the overall user action graph, one or more correlated subgraphs of the overall user action graph; and selecting the target user action graph from the one or more correlated subgraphs.

In general, a user action graph may describe user action sequences associated with a plurality of user profiles. For example, a user action graph may describe a set of user action node each associated with a recorded user action that has been performed by at least n (e.g., at least one) user profiles of the plurality of user profiles, as well as a set of user action sequence edges that each describes that at least m (e.g., at least one) user profiles of the group of profiles have performed a second recorded user action for a second user action node that is associated with a user action sequence edge sequentially after a first recorded user action for a first user action node that is associated with the user action sequence edge. In an exemplary embodiment, when a first user action node describes a recorded user action of clicking on a first button and a second user action node of clicking on a second button, a user action sequence edge may be a directed edge from the first user action node to the second user action node, and may describe that at least m (e.g., at least one) user profile has clicked on the second button sequentially subsequent to clicking on the first button.

In embodiments where an overall user action graph for all of user action data associated with a plurality of user profiles is processed using a community detection routine in order to generate one or more correlated subgraphs of the noted overall user action graph, both the overall user action graph and each of the one or more correlated subgraphs may in some embodiments be deemed a user action graph as described herein. In some embodiments, a user action graph may be generated based at least in part on a set of user action events for a plurality of user profiles, for example user action events related to a corresponding geographic region, user action events related to a corresponding time shift designation, user action events that are associated with a designated recent time period, and/or the like. In some embodiments, the user action data comprise one or more user action events for each user profile, and the one or more user action events for a user profile are recorded by a screen capture component executing on a computing device of the user profile in response to detecting an indication that the user profile has granted permission for the screen capture component to record user activity of the user profile.

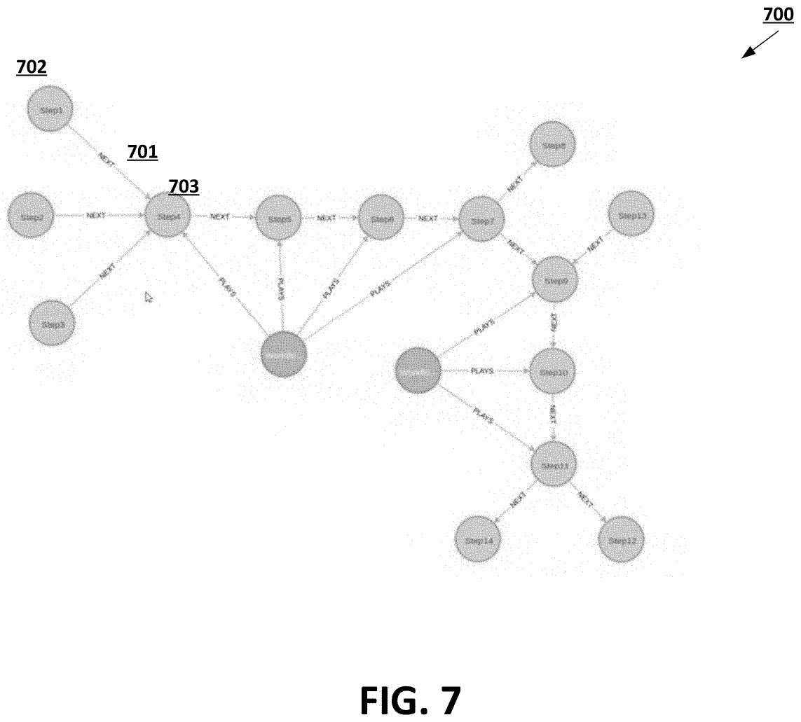

An operational example of an overall user action graph 700 is depicted in FIG. 7. As depicted in FIG. 7, the overall user action graph 700 includes a set of user action nodes connected by a set of user action sequence edges. For example, as depicted in FIG. 7, the user action sequence edge 701 connects the user action node 702 to the user action node 703.

As described above, a user action graph may include a set of user action nodes and a set of user action sequence edges. A user action node describes a recorded user action associated with a plurality of user profiles as part of a user action graph that describes user action sequences associated with a plurality of user profiles. In some embodiments, a user action node describes a recorded user action that has been performed by at least n (e.g., at least one) user profiles of the plurality of user profiles. In an exemplary embodiment, when a first user action node describes a recorded user action of clicking on a first button and a second user action node of clicking on a second button, a user action sequence edge may be a directed edge from the first user action node to the second user action node, and may describe that at least m (e.g., at least one) user profile has clicked on the second button sequentially subsequent to clicking on the first button. In some embodiments, a user action graph comprising a set of user action nodes may be generated based at least in part on a set of user action events for a plurality of user profiles, for example user action events related to a corresponding geographic region, user action events related to a corresponding time shift designation, user action events that are associated with a designated recent time period, and/or the like. In some embodiments, the user action data comprise one or more user action events for each user profile, and the one or more user action events for a user profile are recorded by a screen capture component executing on a computing device of the user profile in response to detecting an indication that the user profile has granted permission for the screen capture component to record user activity of the user profile.

A user action sequence edge may describe a recorded user action sequence between two recorded user actions that are associated with two user action nodes for the user action sequence edge, where the user action sequence edge is part of a user action graph that describes user action sequences associated with a plurality of user profiles. In some embodiments, a user action sequence edge describes that at least m (e.g., at least one) user profiles of the group of profiles have performed a second recorded user action for a second user action node that is associated with a user action sequence edge sequentially after a first recorded user action for a first user action node that is associated with the user action sequence edge. In an exemplary embodiment, when a first user action node describes a recorded user action of clicking on a first button and a second user action node of clicking on a second button, a user action sequence edge may be a directed edge from the first user action node to the second user action node, and may describe that at least m (e.g., at least one) user profile has clicked on the second button sequentially subsequent to clicking on the first button. In some embodiments, a user action graph comprising a set of user action sequence edges may be generated based at least in part on a set of user action events for a plurality of user profiles, for example user action events related to a corresponding geographic region, user action events related to a corresponding time shift designation, user action events that are associated with a designated recent time period, and/or the like. In some embodiments, the user action data comprise one or more user action events for each user profile, and the one or more user action events for a user profile are recorded by a screen capture component executing on a computing device of the user profile in response to detecting an indication that the user profile has granted permission for the screen capture component to record user activity of the user profile.

At step/operation 403, the web server computing entity 106 generates a target user action graph based at least in part on the overall user action graph. In some embodiments, generating a target user action graph comprises generating an overall user action graph based at least in part on the user action data; generating, by applying a community detection routine (e.g., a Louvain community detection algorithm) to the overall user action graph, one or more correlated subgraphs of the overall user action graph; and selecting the target user action graph from the one or more correlated subgraphs.

At step/operation 404, the web server computing entity 106 generates a set of automated testing workflow data entities based at least in part on the target user action graph. In some embodiments, generating the one or more automated testing workflow data entities comprises detecting one or more workflow starting point nodes of the plurality of user action nodes based at least in part on each inward centrality degree score for a user action node; detecting one or more workflow end-point nodes of the plurality of user action nodes based at least in part on each outward centrality degree score for a user action node; and generating the one or more automated testing workflow data entities based at least in part on the one or more workflow starting point nodes and the one or more workflow end-point nodes.

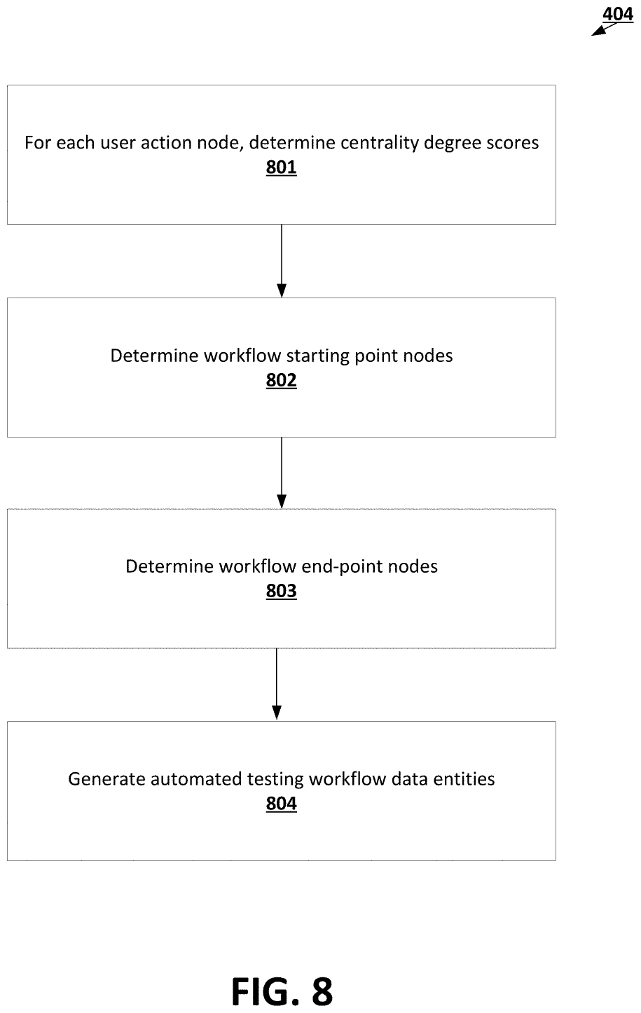

In some embodiments, step/operation 404 may be performed in accordance with the process that is depicted in FIG. 8. The process that is depicted in FIG. 8 at step/operation 801 when the web server computing entity 106 determines a set of centrality degree scores for each user action node in the target user action graph with respect to the target user action graph. In some embodiments, a centrality degree score describes at least one of the following: (i) a number of user action sequence edges in a user action graph that start from a corresponding user action node, and (ii) a number of user action sequence edges in a user action graph that end with a corresponding user action node.

For example, in some embodiments, a centrality degree score describes a number of user action sequence edges in a user action graph that start from a corresponding user action node. As another example, in some embodiments, a centrality degree score describes a number of user action sequence edges in a user action graph that end with a corresponding user action node. As yet another example, in some embodiments, a centrality degree score describes a sum of the following: (i) a number of user action sequence edges in a user action graph that start from a corresponding user action node, and (ii) a number of user action sequence edges in the user action graph that end with the corresponding user action node. In some embodiments, when a centrality degree score describes a number of user action sequence edges in a user action graph that start from a corresponding user action node, the noted centrality degree score is referred to as the inward centrality degree score of the corresponding user action node.

In some embodiments, when a centrality degree score describes a number of user action sequence edges in a user action graph that end with a corresponding user action node, the noted centrality degree score is referred to as the outward centrality degree score of the corresponding user action node. In some embodiments, centrality degree scores are used to determine at least one of the following: a set of workflow starting point nodes of the user action nodes of a user action graph, a set of workflow end-point nodes of the user action nodes of a user action graph, and a set of behavior driving parameters of the set of user action nodes of a user action graph.

At step/operation 802, the web server computing entity 106 determines a set of workflow starting point nodes from the user action nodes of the target user action graph based at least in part on each set of centrality degree scores for a user action node in the target user action graph. In some embodiments, a workflow starting point node describes a user action node of a user action graph that is determined to be a predicted starting point for a sequence of user action nodes described by the user action graph that are deemed suitable to be tested as a unit as an automated testing workflow data entity. For example, in some embodiments, a workflow starting point node may be determined based at least in part on centrality degree scores associated with a set of user action nodes of a user action graph, such as based at least in part on inward centrality degree scores associated with the noted set of user action nodes. In some embodiments, a user action node of a user action graph is deemed to be a workflow starting point node if (e.g., in addition to satisfying one or more other conditions) the user action node is deemed to have a sufficiently low inward centrality degree score, e.g., if the inward centrality degree score for the user action node satisfies (e.g., is below) a lower bound inward centrality degree score threshold, such as a lower bound inward centrality degree score threshold that is a fixed value and/or a lower bound inward centrality degree score threshold that is determined based at least in part on a measure of distribution of inward centrality degree scores for all of the user action nodes associated with the noted user action graph.

At step/operation 803, the web server computing entity 106 determines a set of workflow end-point nodes from the user action nodes of the target user action graph based at least in part on each set of centrality degree scores for a user action node in the target user action graph. In some embodiments, a workflow starting point node describes a user action node of a user action graph that is determined to be a predicted ending point for a sequence of user action nodes described by the user action graph that are deemed suitable to be tested as a unit as an automated testing workflow data entity. For example, in some embodiments, a workflow end-point point node may be determined based at least in part on centrality degree scores associated with a set of user action nodes of a user action graph, such as based at least in part on outward centrality degree scores associated with the noted set of user action nodes. In some embodiments, a user action node of a user action graph is deemed to be a workflow end-point node if (e.g., in addition to satisfying one or more other conditions) the user action node is deemed to have a sufficiently low outward centrality degree score, e.g., if the outward centrality degree score for the user action node satisfies (e.g., is below) a lower bound outward centrality degree score threshold, such as a lower bound outward centrality degree score threshold that is a fixed value and/or a lower bound outward centrality degree score threshold that is determined based at least in part on a measure of distribution of outward centrality degree scores for all of the user action nodes associated with the noted user action graph.

At step/operation 804, the web server computing entity 106 generates the set of automated testing workflow data entities based at least in part on the workflow starting points and the workflow end-points determined above. In some embodiments, each pair of a workflow starting point and a workflow end-point is used to generate a particular automated testing workflow data entity that includes all of the user action nodes that occur on the path between the workflow starting point and the workflow end-point in the pair as the automated testing workflow steps of the noted automated testing workflow data entities. In some embodiments, each pair of a workflow starting point and a workflow end-point is used to generate a particular automated testing workflow data entity that includes all of the user action nodes that occur on the path between the workflow starting point and the workflow end-point in the pair as the automated testing workflow steps of the noted automated testing workflow data entities in the order in which the user action nodes occur in the noted path.

Thus, as described with reference to step/operation 404, various embodiments of the present invention describe techniques for reducing operational load on software testing platforms by automatically generating automated testing workflow data entities. For example, various embodiments of the present invention provide techniques for generating automated testing workflow data entities based at least in part on user action data associated with a plurality of user profiles as well as behavior driving parameters of a user action graph of the user action data. The noted techniques reduce the number of user operations needed to manually define automated testing workflow data entities, which in turn reduces the overall operational load on software testing platforms and increases the computational efficiency and operational reliability of the noted software testing platforms.

Returning to FIG. 4, at step/operation 405, the web server computing entity 106 generates one or more behavior driving parameters of the target user action graph. In some embodiments, step/operation 405 comprises detecting one or more behavior driving parameters based on the plurality of user action nodes based at least in part on each centrality degree for a user action node; and providing access to the one or more behavior driving parameters and alteration data describing relationships between the one or more behavior driving parameters and the one or more automated testing workflow data entities. In some embodiments, step/operation 405 comprises detecting one or more articulation nodes of the plurality of user action nodes; detecting one or more behavior driving parameters of the plurality of user action nodes based at least in part on the one or more articulation nodes; and providing access to the one or more behavior driving parameters and alteration data describing relationships between the one or more behavior driving parameters and the one or more automated testing workflow data entities.

In some embodiments, a behavior driving parameter is a user action node of a user action graph that is associated with a user action value (e.g., a user-assigned value and/or a system-generated value), where the user action value is configured to control the flow of user action sequences in a user action graph in a manner that can be used to infer two or more subgraphs from the user action graph. In some embodiments, a behavior driving parameter can create alternations to an automated testing workflow based at least in part on the user action value associated with the behavior driving parameter. For example, a behavior driving parameter may be associated with a payment method dropdown selection user interface element (e.g., a payment method dropdown selection webpage element) that may alter a checkout testing workflow (e.g., if the user select a credit card payment method, the workflow may be different than when the user selects a gift card payment method). In general, a behavior driving parameter may be associated with a user interface element (e.g., a webpage element) that can hold a value, such as a dropdown menu user interface element, a checkbox user interface element, a set of radio button user interface elements, a textbox user interface element, and/or the like.

In some embodiments, behavior driving parameters are associated with centrality degree scores associated with a set of user action nodes associated with a user action graph, such as with both inward centrality degree scores associated with the noted set of user action nodes and outward centrality degree scores associated with the noted set of user action nodes. In some embodiments, a user action node of a user action graph is deemed to be a behavior driving parameter if (e.g., in addition to satisfying one or more other conditions) the user action node is deemed to have a sufficiently low inward centrality degree score and a sufficiently high outward centrality degree score. For example, in some embodiments, a user action node of a user action graph is deemed to be a behavior driving parameter if (e.g., in addition to satisfying one or more other conditions): (i) the user action node is deemed to have an inward centrality degree score that satisfies (e.g., falls below or is equal to) a lower bound inward centrality degree score threshold (e.g., a fixed lower bound inward centrality degree score threshold such as a fixed lower bound inward centrality degree score threshold of one, a lower bound inward centrality degree score threshold that is determined based at least in part on a measure of distribution of inward centrality degree scores for all of the user action nodes associated with the noted user action graph, and/or the like), and (ii) the user action node is deemed to have an outward centrality degree score that satisfies (e.g., falls above) an upper bound outward centrality degree score threshold (e.g., a fixed upper bound outward centrality degree score threshold, an upper bound outward centrality degree score threshold that is determined based at least in part on a measure of distribution of outward centrality degree scores for all of the user action nodes associated with the noted user action graph, and/or the like).

In some embodiments, a user action node of a user action graph is deemed to be a behavior driving parameter if (e.g., in addition to satisfying one or more other conditions): (i) the user action node is associated with an inward centrality degree score of one, and (ii) the user action node is deemed to have an outward centrality degree score that satisfies (e.g., falls above) an upper bound outward centrality degree score threshold (e.g., a fixed upper bound outward centrality degree score threshold, an upper bound outward centrality degree score threshold that is determined based at least in part on a measure of distribution of outward centrality degree scores for all of the user action nodes associated with the noted user action graph, and/or the like). In some embodiments, a user action node of a user action graph is deemed to be a behavior driving parameter if (e.g., in addition to satisfying one or more other conditions) the user action node is an articulation node (e.g., a node of a graph such as a user action graph whose failure/removal would cause splitting of a user action graph into two or more disconnected subcomponents. In some embodiments, if the user action graph is an undirected graph, a user action node of the user action graph is an articulation node if removing the user action node (and the user action sequence edges through it) disconnects the noted user action graph.

Thus, as described with reference to step/operation 405, various embodiments of the present invention increase the operational effectiveness of software testing platforms by automatically generating automated testing workflow data entities based at least in part on detected patterns of user data. For example, various embodiments of the present invention provide techniques for determining workflow starting point nodes for automated testing workflow data entities, workflow end-point nodes for automated testing workflow data entities, and/or behavior driving parameters from a set of user action nodes of a user action graph that is generated based at least in part on user action events of a particular set of user action data. The automated detection of workflow starting point nodes for automated testing workflow data entities, workflow end-point nodes for automated testing workflow data entities, and/or behavior driving parameters enable performing automated software testing operations in a more comprehensive way and with respect to usage patterns known to users that may be even unknown to test developers. This in turn increases the operational effectiveness and utility of software testing platforms, as well as the operational reliability and user-friendliness of the software applications that are tested and verified using the noted software testing platforms.

At step/operation 406, the web server computing entity 106 provides access to the one or more automated testing workflow data entities and the behavior driving parameters, wherein the one or more automated testing workflow data entities are configured to enable executing one or more automated software testing operations. In some embodiments, the web server computing entity 106 provides access to the one or more behavior driving parameters and alteration data describing relationships between the one or more behavior driving parameters and the one or more automated testing workflow data entities. In some embodiments, step/operation 405 comprises storing JSON scripts describing at least one of the one or more automated testing workflow data entities, the behavior driving parameters, and the alteration data.

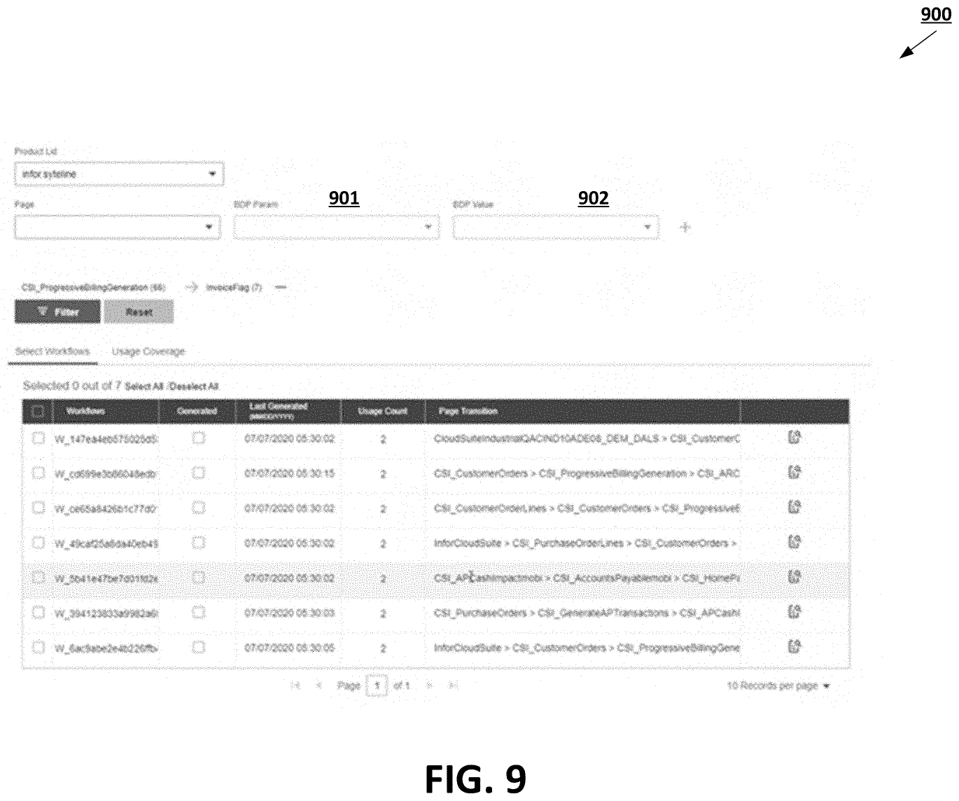

An operational example of a user interface 900 that describes alteration data associated with a set of automated testing workflow data entities is depicted in FIG. 9. As depicted in FIG. 9, the user interface 900 enables displaying a set of automated testing workflow data entities associated with a user action value for a behavior driving parameter, where the user action value is selected using the user interface element 902 and the behavior driving parameter is selected using the user interface element 901.

Accordingly, various embodiments of the present invention describe techniques for reducing operational load on software testing platforms by automatically generating automated testing workflow data entities. For example, various embodiments of the present invention provide techniques for generating automated testing workflow data entities based at least in part on user action data associated with a plurality of user profiles as well as behavior driving parameters of a user action graph of the user action data. The noted techniques reduce the number of user operations needed to manually define automated testing workflow data entities, which in turn reduces the overall operational load on software testing platforms and increases the computational efficiency and operational reliability of the noted software testing platforms.

Moreover, various embodiments of the present invention increase the operational effectiveness of software testing platforms by automatically generating automated testing workflow data entities based at least in part on detected patterns of user data. For example, various embodiments of the present invention provide techniques for determining workflow starting point nodes for automated testing workflow data entities, workflow end-point nodes for automated testing workflow data entities, and/or behavior driving parameters from a set of user action nodes of a user action graph that is generated based at least in part on user action events of a particular set of user action data. The automated detection of workflow starting point nodes for automated testing workflow data entities, workflow end-point nodes for automated testing workflow data entities, and/or behavior driving parameters enable performing automated software testing operations in a more comprehensive way and with respect to usage patterns known to users that may be even unknown to test developers. This in turn increases the operational effectiveness and utility of software testing platforms, as well as the operational reliability and user-friendliness of the software applications that are tested and verified using the noted software testing platforms.

### CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for detecting one or more automated testing workflow data entities based at least in part on user action data, the computer-implemented method comprising:
generating, using a processor, a user action graph associated with the user action data, wherein the user action graph comprises: (i) a plurality of user action nodes corresponding to a plurality of recorded user actions, and (ii) one or more user action sequence edges that describe sequential relationships across the plurality of recorded user actions;
for each user action node, determining, using the processor, one or more centrality degree scores with respect to the user action graph;
detecting, using the processor, the one or more one or more automated testing workflow data entities based at least in part on each centrality degree for a user action node; and
providing access, using the processor, to the one or more automated testing workflow data entities, wherein the one or more automated testing workflow data entities are configured to enable executing one or more automated software testing operations.

2. The computer-implemented method of claim 1, wherein generating the user action graph comprises:
generating an overall user action graph based at least in part on the user action data;
generating, by applying a community detection routine to the overall user action graph, one or more correlated subgraphs of the overall user action graph; and
selecting the user action graph from the one or more correlated subgraphs.

3. The computer-implemented method of claim 1, wherein the one or more centrality degree scores for a user action node comprise an inward centrality degree score and an outward centrality degree score.

4. The computer-implemented method of claim 3, wherein generating the one or more automated testing workflow data entities comprises:
detecting one or more workflow starting point nodes of the plurality of user action nodes based at least in part on each inward centrality degree score for a user action node;
detecting one or more workflow end-point nodes of the plurality of user action nodes based at least in part on each outward centrality degree score for a user action node; and
generating the one or more automated testing workflow data entities based at least in part on the one or more workflow starting point nodes and the one or more workflow end-point nodes.

5. The computer-implemented method of claim 1, further comprising:
detecting, using the processor, one or more behavior driving parameters of the plurality of user action nodes based at least in part on each centrality degree for a user action node; and
providing access, using the processor, to the one or more behavior driving parameters and alteration data describing relationships between the one or more behavior driving parameters and the one or more automated testing workflow data entities.

6. The computer-implemented method of claim 1, further comprising:
detecting, using the processor, one or more articulation nodes of the plurality of user action nodes;
detecting, using the processor, one or more behavior driving parameters of the plurality of user action nodes based at least in part on the one or more articulation nodes; and
providing access, using the processor, to the one or more behavior driving parameters and alteration data describing relationships between the one or more behavior driving parameters and the one or more automated testing workflow data entities.

7. The computer-implemented method of claim 1, wherein the user action data comprise user action events related to a corresponding geographic region.

8. The computer-implemented method of claim 1, wherein the user action data comprise user action events related to a corresponding time shift designation.

9. The computer-implemented method of claim 1, wherein the user action data comprise user action events that are associated with a designated recent time period.

10. The computer-implemented method of claim 1, wherein:
the user action data comprise one or more user action events for each user profile; and
the one or more user action events for a user profile are recorded by a screen capture component executing on a computing device of the user profile in response to detecting an indication that the user profile has granted permission for the screen capture component to record user activity of the user profile.

11. An apparatus for detecting one or more automated testing workflow data entities based at least in part on user action data associated with a plurality of user profiles, the apparatus comprising at least one processor and at least one memory including program code, the at least one memory and the program code configured to, with the processor, cause the apparatus to at least:
generate a user action graph associated with the user action data, wherein the user action graph comprises: (i) a plurality of user action nodes corresponding to a plurality of recorded user actions, and (ii) one or more user action sequence edges that describe sequential relationships across the plurality of recorded user actions;
for each user action node, determine one or more centrality degree scores with respect to the user action graph;
detect the one or more one or more automated testing workflow data entities based at least in part on each centrality degree for a user action node; and
provide access to the one or more automated testing workflow data entities, wherein the one or more automated testing workflow data entities are configured to enable executing one or more automated software testing operations.

12. The apparatus of claim 11, wherein generating the user action graph comprises:
generating an overall user action graph based at least in part on the user action data;
generating, by applying a community detection routine to the overall user action graph, one or more correlated subgraphs of the overall user action graph; and
selecting the user action graph from the one or more correlated subgraphs.

13. The apparatus of claim 11, wherein the one or more centrality degree scores for a user action node comprise an inward centrality degree score and an outward centrality degree score.

14. The apparatus of claim 13, wherein generating the one or more automated testing workflow data entities comprises:
detecting one or more workflow starting point nodes of the plurality of user action nodes based at least in part on each inward centrality degree score for a user action node;
detecting one or more workflow end-point nodes of the plurality of user action nodes based at least in part on each outward centrality degree score for a user action node; and
generating the one or more automated testing workflow data entities based at least in part on the one or more workflow starting point nodes and the one or more workflow end-point nodes.

15. The apparatus of claim 11, wherein the at least one memory and the program code are configured to, with the processor, cause the apparatus to at least:
detecting one or more behavior driving parameters of the plurality of user action nodes based at least in part on each centrality degree for a user action node; and
providing access to the one or more behavior driving parameters and alteration data describing relationships between the one or more behavior driving parameters and the one or more automated testing workflow data entities.

16. The apparatus of claim 11, wherein the at least one memory and the program code are configured to, with the processor, cause the apparatus to at least:
detecting one or more articulation nodes of the plurality of user action nodes;
detecting one or more behavior driving parameters of the plurality of user action nodes based at least in part on the one or more articulation nodes; and
providing access to the one or more behavior driving parameters and alteration data describing relationships between the one or more behavior driving parameters and the one or more automated testing workflow data entities.

17. The apparatus of claim 11, wherein the user action data comprise user action events related to a corresponding geographic region.

18. The apparatus of claim 11, wherein the user action data comprise user action events related to a corresponding time shift designation.

19. The apparatus of claim 11, wherein the user action data comprise user action events that are associated with a designated recent time period.

20. A computer program product for detecting one or more automated testing workflow data entities based at least in part on user action data associated with a plurality of user profiles, the computer program product comprising at least one non-transitory computer-readable storage medium having computer-readable program code portions stored therein, the computer-readable program code portions configured to:
generate a user action graph associated with the user action data, wherein the user action graph comprises: (i) a plurality of user action nodes corresponding to a plurality of recorded user actions, and (ii) one or more user action sequence edges that describe sequential relationships across the plurality of recorded user actions;
for each user action node, determine one or more centrality degree scores with respect to the user action graph;
detect the one or more one or more automated testing workflow data entities based at least in part on each centrality degree for a user action node; and
provide access to the one or more automated testing workflow data entities, wherein the one or more automated testing workflow data entities are configured to enable executing one or more automated software testing operations.
